(19) United States
(12) Patent Application Publication
(10) Pub. No.: US 2020/0073492 A1
(43) Pub. Date: Mar. 5, 2020

(54) TOUCH APPARATUS

(71) Applicant: Chunghwa Picture Tubes, LTD., Taoyuan City (TW)

(72) Inventors: Kun-Chi Chiu, Taoyuan City (TW); Chun-Chung Wu, Taoyuan City (TW); Chao-Wei Wei, Taoyuan City (TW); Chi-Lun Wu, Taoyuan City (TW); Wei-Fu Chang, Taoyuan City (TW)

(73) Assignee: Chunghwa Picture Tubes, LTD., Taoyuan City (TW)

(21) Appl. No.: 16/194,405

(22) Filed: Nov. 19, 2018

(30) Foreign Application Priority Data
Aug. 29, 2018 (CN) 201810995210.7

(51) Int. Cl. G06F 3/044; G06F 3/0354; G06F 3/041

(52) U.S. Cl. CPC G06F 3/044; G06F 3/0414; G06F 3/0412; G06F 3/03547

(57) ABSTRACT

A touch apparatus including a control button and a touch panel is provided. The control button includes an insulating main body and a conductive member disposed on the insulating main body. The touch panel is disposed on a side of the control button, and the touch panel includes a cover plate and a touch-sensing element. The conductive member is located between the insulating main body and the cover plate. The cover plate is located between the control button and the touch-sensing element. The touch-sensing element is electrically insulated from the conductive member. The touch-sensing element includes a plurality of electrodes disposed corresponding to the control button. The conductive member moves along with the movement of the insulating main body, and the movement of the conductive member causes a capacitance change of at least one of the plurality of electrodes.

### CROSS-REFERENCE TO RELATED APPLICATION

This application claims the priority benefit of China application serial no. 201810995210.7, filed on Aug. 29, 2018. The entirety of the above-mentioned patent application is hereby incorporated by reference herein and made a part of this specification.

### BACKGROUND

### Field of the Disclosure

The disclosure relates to an electronic apparatus, more specifically relates to a touch apparatus.

### Description of Related Art

The existing electronic apparatus is equipped with a touch panel to provide a more intuitive and convenient touch operating function. Some of the touch apparatuses are also equipped with control buttons (such as knobs) to allow the user to have a physical touch during operation (such as pressing or rotating). The existing control buttons are mainly made of conductive materials such as metal. The touch detection is performed by sensing capacitance change caused by the user touching the control button when operating. Under this structure, the user must operate (for example, to press or to rotate) the control button with bare hand. In other words, the user wearing the glove (such as non-conductive glove made by wool or plastic) cannot operate the control button. Moreover, since the metal material conduct heat easily, the temperature of the control button made of metal is easily affected by the environment. For example, if the control button is exposed to cold environment, the user will feel cold when touching the control button. On the other hand, if the control button is exposed to the sun for a long time, the user may be burnt when touching the control button.

### SUMMARY

The disclosure provides a touch apparatus in which the temperature of the control button is not easily affected by ambient temperature, and the user can operate the control button while wearing the glove.

In one embodiment of the disclosure, a touch apparatus includes a control button and a touch panel. The control button includes an insulating main body and a conductive member disposed on the insulating main body. The touch panel is disposed on a side of the control button, and the touch panel includes a cover plate and a touch-sensing element. The conductive member is located between the insulating main body and the cover plate. The cover plate is located between the conductive member and the touch-sensing element. The touch-sensing element is electrically insulated from the conductive member. The touch-sensing element includes a plurality of electrodes disposed corresponding to the control button. The conductive member moves along with the movement of the insulating main body, and the movement of the conductive member causes a capacitance change of at least one of the plurality of electrodes.

In one embodiment of the touch apparatus of the disclosure, the conductive member includes at least one elastic piece, and the control button further includes a circuit board. The circuit board is located between the conductive member and the touch panel. The circuit board includes a circuit substrate, a first circuit layer and a second circuit layer. The circuit substrate has a first surface and a second surface. The second surface is located between the conductive member and the first surface. The first circuit layer is disposed on the first surface. The first circuit layer includes a plurality of first electrodes, and the plurality of first electrodes respectively overlap the plurality of electrodes of the touch-sensing element. The second circuit layer is disposed on the second surface and electrically connected to the first circuit layer. The movement of the insulating main body causes the conductive member to be in contact with the second circuit layer.

In one embodiment of the touch apparatus of the disclosure, the circuit board does not move along with the movement of the insulating main body.

In one embodiment of the touch apparatus of the disclosure, the at least one elastic piece comprises a first elastic piece and a plurality of second elastic pieces. The first elastic piece is shorter than each of the second elastic pieces. The second circuit layer comprises a first conductive wire, a second conductive wire, a third conductive wire, a first ground wire and a second ground wire. The first conductive wire, the first ground wire, the second conductive wire, the second ground wire and the third conductive wire are sequentially arranged in a concentric manner from inside to outside or from outside to inside. The first conductive wire, the second conductive wire, the third conductive wire and the first ground wire are continuous conductive wires. The second ground wire is constituted by a plurality of conducting portions, and the plurality of conducting portions are separated from each other. When the insulating main body is pressed, the first elastic piece is in contact with the first conductive wire and the first ground wire. When the insulating main body is rotated, the plurality of second elastic pieces are respectively in contact with the second conductive wire and the third conductive wire, and the plurality of second elastic pieces are intermittently in contact with the plurality of conducting portions.

In one embodiment of the touch apparatus of the disclosure, the second circuit layer includes a plurality of second electrodes. The plurality of second electrodes of the second circuit layer are overlapped with and electrically connected to the plurality of first electrodes of the first circuit layer, respectively. The first circuit layer further includes a first ground ring. The second circuit layer further includes a second ground ring. The touch-sensing element further includes a third ground ring. The first ground ring and the second ground ring are electrically connected to each other. The first ground ring, the second ground ring, and the third ground ring are overlapped with each other. When the insulating main body is rotated, the at least one elastic piece is in contact with one of the plurality of second electrodes of the second circuit layer and the second ground ring.

In one embodiment of the touch apparatus of the disclosure, the control button further includes a plurality of position restricted parts. The plurality of position restricted parts are fixed on the second surface and disposed along a periphery of the insulating main body.

In one embodiment of the touch apparatus of the disclosure, the conductive member includes a conductive pad. The plurality of electrodes of the touch-sensing element include a plurality of signal electrodes and a plurality of ground electrodes. The plurality of signal electrodes and the plurality of ground electrodes are alternately arranged along a circumferential direction of the insulating main body. The area of the conductive pad is 1.5 to 2 times the area of each of the plurality of signal electrodes, and the area of the conductive pad is 1.5 to 2 times an area of each of the plurality of ground electrodes.

In one embodiment of the touch apparatus of the disclosure, the conductive member includes a conductive pad. The plurality of electrodes of the touch-sensing element include a plurality of driving electrodes, a plurality of sensing electrodes and a plurality of ground electrodes. The plurality of driving electrodes, the plurality of sensing electrodes and the plurality of ground electrodes are alternately arranged along a circumferential direction of the insulating main body. The area of the conductive pad is 2.5 to 3 times the area of each of the plurality of driving electrodes. The area of the conductive pad is 2.5 to 3 times the area of each of the plurality of sensing electrodes. The area of the conductive pad is 2.5 to 3 times the area of each of the plurality of ground electrodes.

In one embodiment of the touch apparatus of the disclosure, the insulating main body has a center opening, and the center opening exposes at least one of the plurality of electrodes of the touch-sensing element.

In one embodiment of the touch apparatus of the disclosure, the touch apparatus further includes a display device, wherein the touch-sensing element is located between the cover plate and the display device.

Based on the above, according to embodiments of the touch apparatus of the disclosure, the main body of the control button is made of insulating material. Since the insulating material is not easy to conduct heat, the temperature of the control button is not easily affected by ambient temperature, and the user can operate the control button while wearing the glove.

In order to make the aforementioned and other features and advantages of the disclosure more comprehensible, embodiments accompanying figures are described in detail belows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is an exploded view of a touch apparatus according to the first embodiment of the disclosure.

FIG. 2A to FIG. 2D are respectively front views showing the relative relationship in operation between a second circuit layer and a conductive member in FIG. 1.

FIG. 3 is a schematic view showing a truth table corresponding to FIG. 2A to FIG. 2D.

FIG. 4 is an enlarged front view of a touch-sensing element in FIG. 1.

FIG. 5 is an exploded view of a touch apparatus according to the second embodiment of the disclosure.

FIG. 6 is an enlarged front view of a touch-sensing element in FIG. 5.

FIG. 7 is an exploded view of a touch apparatus according to the third embodiment of the disclosure.

FIG. 8 is a front view showing the relative relationship in operation between a second circuit layer and a conductive member in FIG. 7.

FIG. 9 is an exploded view of a touch apparatus according to the fourth embodiment of the disclosure.

### DESCRIPTION OF THE EMBODIMENTS

The directional terminologies mentioned in the description of the embodiments, such as “top”, “bottom”, “left”, “right”, “front”, or “back”, etc., are used with reference to the direction in the drawings. Accordingly, the drawings and descriptions will be regarded as illustrative in nature and not as restrictive. In the drawings, each of the figures shows typical features of the methods, structures, and/or materials used in the particular exemplary embodiment(s). However, the drawings are not to be interpreted as limitation or limiting the scope or nature of the embodiments disclosed. For example, for the purpose of clarity, the relative thickness and location of the various layers, regions and/or structures may be minified or magnified.

In the description of the embodiments, the same or similar elements will be given the same or similar reference numerals, and their description will be omitted. In addition, the features in the different exemplary embodiments can be combined with each other as long as there is no conflict, and equivalent changes and modifications made in the specification or claims are still within the scope of this disclosure. Moreover, the terms “first”, “second” and the like mentioned in the specification and the claims are merely used to designate discrete elements or to differentiate different ranges or embodiments, and are not intended to limit the upper or lower bound of the number of the components/devices, nor to limit the manufacturing sequence of components.

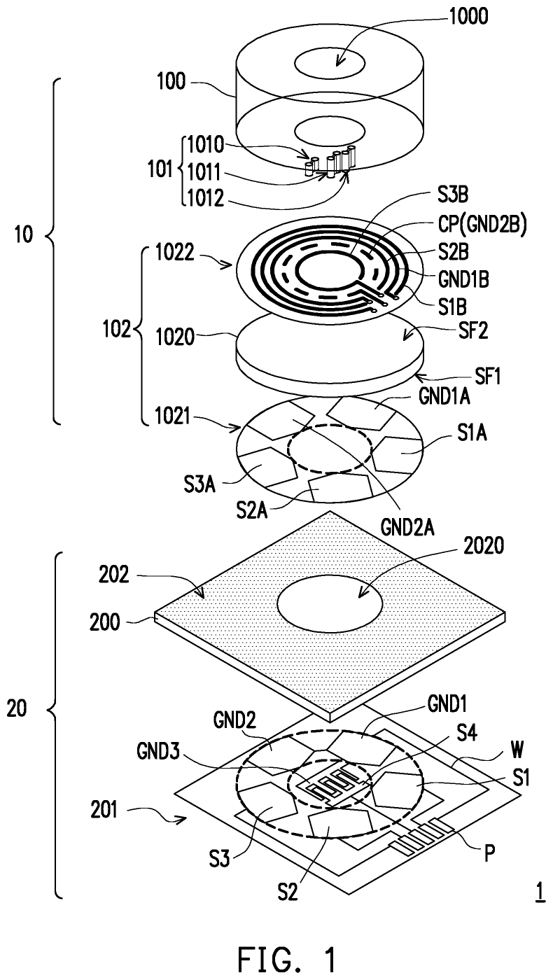

FIG. 1 is an exploded view of a touch apparatus 1 according to the first embodiment of the disclosure. Referring to FIG. 1, the touch apparatus 1 includes a control button 10 and a touch panel 20. The control button 10 includes an insulating main body 100 and a conductive member 101. The touch panel 20 is disposed on a side of the control button 10, and the touch panel 20 includes a cover plate 200 and a touch-sensing element 201. The conductive member 101 is located between the insulating main body 100 and the cover plate 200. The cover plate 200 is located between the conductive member 101 and the touch-sensing element 201, and the touch-sensing element 201 is electrically insulated from the conductive member 101. The touch-sensing element 201 includes a plurality of electrodes (such as electrode S1, electrode S2, electrode S3, electrode S4, electrode GND1, electrode GND2, and electrode GND3) disposed corresponding to the control button 10. The conductive member 101 moves along with the movement of the insulating main body 100, and the movement of the conductive member 101 causes a capacitance change of at least one of the plurality of electrodes.

To be more specific, the insulating main body 100 is the element that the user touches when operating the control button 10. The user's operation on the control button 10 may include pressing and rotating. Correspondingly, the movement of the insulating main body 100 may include displacement in the longitudinal direction and rotation.

The insulating main body 100 is made of an insulating material. The insulating material may include plastic, but the disclosure is not limited thereto. Since the insulating material is not easy to conduct heat, the temperature of the control button 10 is not easily affected by ambient temperature. For example, it is not easy to feel cold when touching and operating the control button 10 in cold environment, and it is not easy to be burnt when operating the control button 10 that is exposed to the sun for a long time.

The shape of the insulating main body 100 may be designed according to the movement of the control button 10. For example, if the movement of the control button 10 is only the displacement in the longitudinal direction (e.g. serving as a switch), the shape of the insulating main body 100 may be any shape, such as circular shape, triangle shape, rectangle shape, or other polygonal shapes. If the movement of the control button 10 includes rotation (e.g. serving as a control unit for controlling parameters like: temperature, humidity, wind speed, volume of sound, etc.), the shape of the insulating main body 100 may be circular shape or other shapes having indicative/directional characteristic. In the embodiment, the shape of the insulating main body 100 is circular, and the insulating main body 100 has a center opening 1000. The center opening 1000 penetrates through the insulating main body 100 and is configured to expose an element located under the insulating main body 100 (the description will be provided below).

The conductive member 101 is disposed on the insulating main body 100. For example, the conductive member 101 may be fixed on a surface, which faces the touch panel 20, of the insulating main body 100 by any known methods (such as adhesion or welding methods). The conductive member 101 is made of conductive material. The conductive material may include metal, but the disclosure is not limited thereto. In the embodiment, the conductive member 101 includes a first elastic piece 1010 and a plurality of second elastic pieces (such as a second elastic piece 1011 and a second elastic piece 1012), and the first elastic piece 1010 is shorter than each of the second elastic pieces (which includes the second elastic piece 1011 and the second elastic piece 1012).

In the embodiment, the control button 10 further includes a circuit board 102. The circuit board 102 is located between the conductive member 101 and the touch panel 20. The circuit board 102 includes a circuit substrate 1020, a first circuit layer 1021 and a second circuit layer 1022. The circuit substrate 1020 has a first surface SF1 and a second surface SF2, and the second surface SF2 is located between the conductive member 101 and the first surface SF1. In other words, the first surface SF1 and the second surface SF2 are two opposite surfaces of the circuit substrate 1020, wherein the first surface SF1 faces the touch panel 20, and the second surface SF2 faces the conductive member 101.

The first circuit layer 1021 is disposed on the first surface SF1. The first circuit layer 1021 includes a plurality of first electrodes (such as a first electrode S1A, a first electrode S2A, a first electrode S3A, a first electrode GND1A, and a first electrode GND2A), and the plurality of first electrodes respectively overlap the plurality of electrodes of the touch-sensing element 201. To be more specific, the first electrode S1A of the first circuit layer 1021 overlaps the electrode S1 of the touch-sensing element 201. The first electrode S2A of the first circuit layer 1021 overlaps the electrode S2 of the touch-sensing element 201. The first electrode S3A of the first circuit layer 1021 overlaps the electrode S3 of the touch-sensing element 201. The first electrode GND1A of the first circuit layer 1021 overlaps the electrode GND1 of the touch-sensing element 201. The first electrode GND2A of the first circuit layer 1021 overlaps the electrode GND2 of the touch-sensing element 201.

The second circuit layer 1022 is disposed on the second surface SF2 and electrically connected to the first circuit layer 1021. In the embodiment, the second circuit layer 1022 adopts a different circuit design than the first circuit layer 1021. Specifically, the second circuit layer 1022 includes a first conductive wire S1B, a second conductive wire S2B, a third conductive wire S3B, a first ground wire GND1B, and a second ground wire GND2B. The first conductive wire S1B, the first ground wire GND1B, the second conductive wire S2B, the second ground wire GND2B, and the third conductive wire S3B are sequentially arranged in a concentric manner from inside to outside or from outside to inside. FIG. 1 shows the sequential arrangement from outside to inside, but the disclosure is not limited thereto. The first conductive wire S1B, the second conductive wire S2B, the third conductive wire S3B, and the first ground wire GND1B are continuous conductive wires. The second ground wire GND2B is constituted by a plurality of conducting portions CP, and the plurality of conducting portions CP are separated from each other.

The first conductive wire S1B is electrically connected to the first electrode S1A of the first circuit layer 1021 through a circuit (not shown) inside the circuit substrate 1020. The second conductive wire S2B is electrically connected to the first electrode S2A of the first circuit layer 1021 through a circuit (not shown) inside the circuit substrate 1020. The third conductive wire S3B is electrically connected to the first electrode S3A of the first circuit layer 1021 through a circuit (not shown) inside the circuit substrate 1020. The first ground wire GND1B is electrically connected to the first electrode GND1A of the first circuit layer 1021 through a circuit (not shown) inside the circuit substrate 1020. The plurality of conducting portions CP of the second ground wire GND2B is electrically connected to the first electrode GND2A of the first circuit layer 1021 through a circuit (not shown) inside the circuit substrate 1020.

The cover plate 200 of the touch panel 20 cover the entire surface of the touch-sensing element 201 as an example, and the control button 10 may be fixed to the cover plate 200 of the touch panel 20 through an adhesive layer or other fixing elements. As a result, the cover plate 200 can protect the elements (such as the touch-sensing element 201) under the cover plate 200. Besides, the conductive element(s)/circuit(s) (such as conductive member 101, the first circuit layer 1021, and the second circuit layer 1022) located on the cover plate 200 and the element(s)/circuit(s) (such as the touch-sensing element 201) located under the cover plate 200 are structurally separated by the cover plate 200 and are thus electrically insulated from each other. For example, the cover plate 200 may be a glass cover plate or a plastic cover plate, but the disclosure is not limited thereto.

In the embodiment, the touch panel 20 may further include a decorative layer 202. The decorative layer 202 is disposed on the cover plate 200 and shields the elements that are not intended to be seen by the user. Specifically, in addition to the plurality of electrodes (such as the electrode S1, the electrode S2, the electrode S3, the electrode S4, the electrode GND1, the electrode GND2, and the electrode GND3), the touch-sensing element 201 may further include a plurality of conductive wires W and a plurality of pads P. The plurality of electrodes of the touch-sensing element 201 may be respectively electrically connected to at least one of the pads P through at least one of the conductive wires W, such that each of the plurality of electrodes of the touch-sensing element 201 may be electrically connected to a control chip (not shown) through the corresponding pad P. The conductive wires W and the pads P are usually made of metal material to have ideal conductivity. However, the metal material is opaque and thus affect the display effect easily. Therefore, the conductive wires W and the pads P are shield by the decorative layer 202, so as to have ideal display effect and appearance.

In the embodiment, the decorative layer 202 covers/shields the conductive wires W and the pads P and further covers/shields the electrode S1, the electrode S2, the electrode S3, the electrode GND1, and the electrode GND2. Moreover, the decorative layer 202 has an opening 2020. The opening 2020 overlaps the center opening 1000 of the insulating main body 100, and the opening 2020 exposes the electrode S4 and the electrode GND3. To be more specific, a display device (not shown) may be integrated into the touch apparatus 1, and the information is displayed in the region exposed by the opening 2020. Moreover, through the arrangement of the center opening 1000 of the insulating main body 100 and through arranging the electrode S4 and the electrode GND3 in the region corresponding to the center opening 1000/opening 2020, the center of the control button 10 can not only display information but also provide a function of touch operation. Under this structure, the electrode S4 and the electrode GND3 may be made of a transparent and conductive material, so as to avoid affecting the display effect of the region. The transparent and conductive material may include metal-oxide, but the disclosure is not limited thereto.

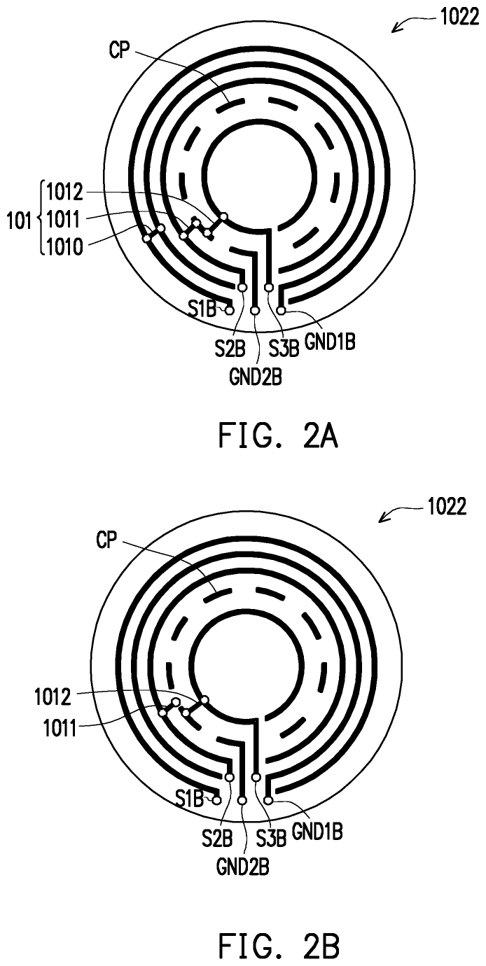

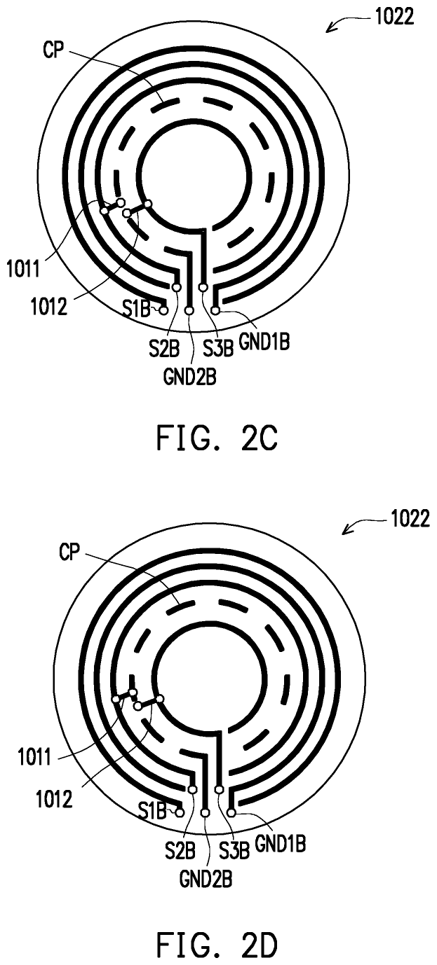

In the embodiment, the electrode S1, the electrode S2, the electrode S3, the electrode GND1, and the electrode GND2 in the touch-sensing element 201 may be used for determining the movement of the insulating main body 100. To be more specific, the electrode S1 and the electrode GND1 together with the first elastic piece 1010 having shorter length may be used to determine whether the insulating main body 100 is pressed, and the electrode S2, the electrode S3, and the electrode GND2 together with every second elastic piece (including the second elastic piece 1011 and the second elastic piece 1012) having longer length may be used to determine the way that the insulating main body 100 is rotated (such as clockwise rotation or counterclockwise rotation). FIG. 2A to FIG. 2D are respectively front views showing the relative relationship in operation between the second circuit layer 1022 and the conductive member 101 in FIG. 1. FIG. 3 is a schematic view showing a truth table corresponding to FIG. 2A to FIG. 2D. In the truth table, “0” represents that the signal change (such as capacitance change) is generated, and “1” represents that no signal change is generated.

Referring to FIGS. 1 to 3, when the insulating main body 100 is pressed, the first elastic piece 1010 having shorter length and every second elastic piece (including the second elastic piece 1011 and the second elastic piece 1012) having longer length are pressed downward together along with the insulating main body 100, and the first elastic piece 1010 and the second elastic pieces touch the second circuit layer 1022, wherein the first elastic piece 1010 is in contact with the first conductive wire S1B and the first ground wire GND1B (as shown in FIG. 2A), so that the electrode S1 of the touch-sensing element 201 correspondingly generates signal change (such as capacitance change), and thus determine that the insulating main body 100 is pressed.

When the insulating main body is rotated, the plurality of second elastic pieces (including the second elastic piece 1011 and the second elastic piece 1012) are respectively in contact with the second conductive wire S2B and the third conductive wire S3B, and the plurality of second elastic pieces are intermittently in contact with the plurality of conducting portions CP. For example, the locations of the plurality of second elastic pieces are changed in clockwise direction as shown from the FIG. 2A to the FIG. 2D. In the control button 10 of the embodiment, the element that moves along with the movement (displacement in the vertical direction or rotation) of the insulating main body 100 is the conductive member 101, and the circuit board 102 does not move along with the movement of the insulating main body 100. Therefore, in FIG. 2A to FIG. 2D, only the location of the conductive member 101 (such as the second elastic piece 1011 and the second elastic piece 1012) are changed, and the location of the second circuit layer 1022 is not changed.

In FIG. 2A, the second elastic piece 1011 is in contact with the second conductive wire S2B and the conducting portion CP of the second ground wire GND2B, so that the electrode S2 of the touch-sensing element 201 generates signal change (such as capacitance change) correspondingly. In addition, the second elastic piece 1012 is in contact with the third conductive wire S3B and the conducting portion CP of the second ground wire GND2B, so that the electrode S3 of the touch-sensing element 201 generates signal change correspondingly.

The second elastic piece 1011 and the second elastic piece 1012 are then rotated clockwise to move to the locations shown in FIG. 2B. At this time, the second elastic piece 1011 is in contact with the second conductive wire S2B but is not in contact with the conducting portion CP of the second ground wire GND2B, so that the electrode S2 of the touch-sensing element 201 does not generate signal change. On the other hand, the second elastic piece 1012 is still in contact with the third conductive wire S3B and the conducting portion CP of the second ground wire GND2B, so that the electrode S3 of the touch-sensing element 201 still generates signal change.

The second elastic piece 1011 and the second elastic piece 1012 are continuously rotated clockwise to move to the locations shown in FIG. 2C. At this time, the second elastic piece 1011 is in contact with the second conductive wire S2B but is not in contact with the conducting portion CP of the second ground wire GND2B, and the second elastic piece 1012 is in contact with the third conductive wire S3B but is not in contact with the conducting portion CP of the second ground wire GND2B. Therefore, the electrode S2 and the electrode S3 of the touch-sensing element 201 all do not generate signal change.

The second elastic piece 1011 and the second elastic piece 1012 are continuously moved to the locations shown in FIG. 2D. At this time, the second elastic piece 1011 is in contact with the second conductive wire S2B and the conducting portion CP of the second ground wire GND2B, so that the electrode S2 of the touch-sensing element 201 generates signal change correspondingly. On the other hand, the second elastic piece 1012 is still in contact with the third conductive wire S3B but is not in contact with the conducting portion CP of the second ground wire GND2B, so that the electrode S3 of the touch-sensing element 201 still does not generate signal change.

The left half in FIG. 3 shows signal changes of the electrode S2 and the electrode S3 of the touch-sensing element 201 corresponding to FIGS. 2A to 2D (the second elastic piece is rotated clockwise from FIG. 2A to FIG. 2D). The right half in FIG. 3 shows signal changes of the electrode S2 and the electrode S3 of the touch-sensing element 201 corresponding to FIGS. 2D to 2A (the second elastic piece is rotated counterclockwise from FIG. 2D to FIG. 2A). Based on the difference in time sequence of the signal change (as shown in FIG. 3) caused by clockwise and counterclockwise rotations, the rotation direction (clockwise rotation or counterclockwise rotation) of the insulating main body 100 can be determined. In the embodiment, through the elastic piece of the conductive member 101 being in contact with the circuit (conductive wire/ground wire) in the second circuit layer 1022, the electrode in the first circuit layer 1021 makes the corresponding electrode in the touch-sensing element 201 generate capacitance change with respect to the ground, so as to realize self-capacitive touch sensing. Since touch determination is not performed by using capacitance change caused by the user's hand contacting a conductive body, the user can operate the control button 10 even if wearing the glove.

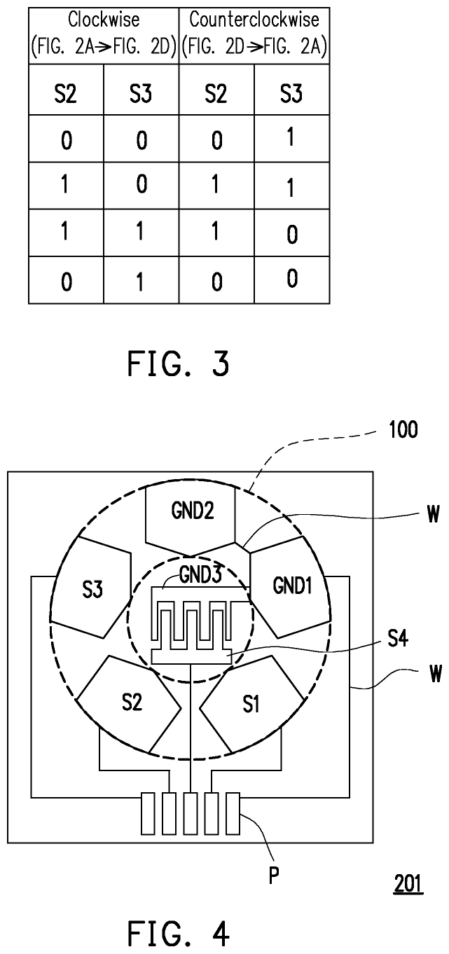

FIG. 4 is an enlarged front view of the touch-sensing element 201 in FIG. 1. Referring to FIG. 4, the electrode S1, the electrode S2, the electrode S3, the electrode GND1, and the electrode GND2 of the touch-sensing element 201 are arranged along a circumferential direction of the insulating main body 100 and are covered by the insulating main body 100 (the thick dashed line in FIG. 4). The electrode S4 and the electrode GND3 are disposed corresponding to the center opening 1000 of the insulating main body 100 and are surrounded by the electrode S1, the electrode S2, the electrode S3, the electrode GND1, and the electrode GND2. In the embodiment, the electrode GND1 and the electrode GND2 are electrically connected to each other through one conductive wire W, and the electrode GND3 and the electrode GND1 are in direct contact/connection. However, the elements in the touch-sensing element 201, the number of these elements, and the relative arranging relationship of these elements (such as the electrodes, the conductive wires W, and the pads P) in the touch-sensing element 201 may be adjusted according to requirement and are not limited by FIG. 4.

In addition, the touch-sensing element 201 may be formed on the cover plate 200. Alternatively, the touch-sensing element 201 may be formed on an additional carrier board (not shown) and then attached to the cover plate 200. In one embodiment, the cover plate 200 may be an opposite substrate (or a color filter substrate) of a display module. In other words, the touch-sensing element 201 may be formed in the display module, and the control button 10 is attached on the opposite substrate, so as to form an embedded touch display module. Alternatively, the touch-sensing element 201 may be formed on the outer surface of the opposite substrate of the display module or may be formed on the cover plate 200, and the cover plate 200 and the control button 10 are sequentially attached to the display module, so as to form an external touch display module.

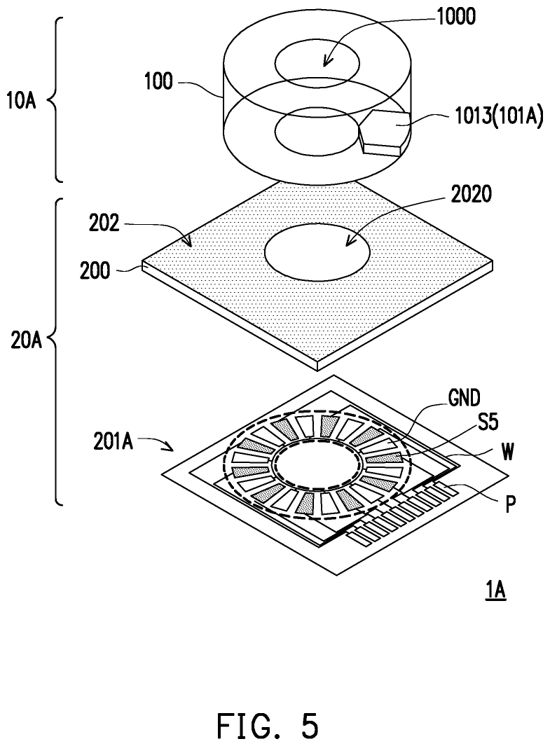

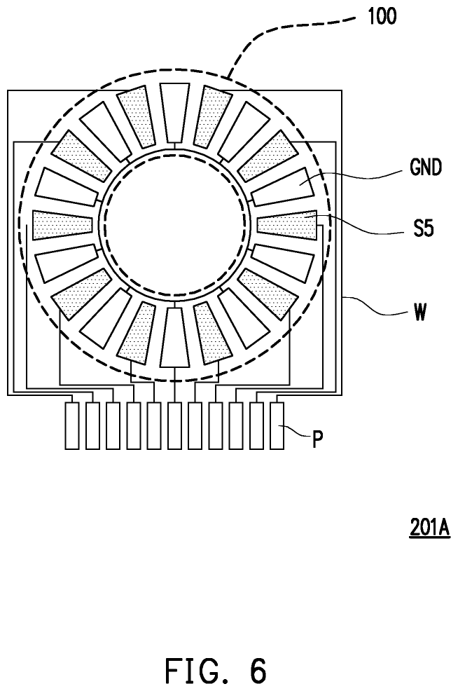

FIG. 5 is an exploded view of a touch apparatus 1A according to the second embodiment of the disclosure. FIG. 6 is an enlarged front view of a touch-sensing element 201A in FIG. 5. Referring to FIG. 5 and FIG. 6, the main differences between the touch apparatus 1A and the touch apparatus 1 in FIG. 1 are described as follows. In the touch apparatus 1A, a conductive member 101A of the control button 10A includes a conductive pad 1013 in replacement of the first elastic piece 1010, the second elastic piece 1011, and the second elastic piece 1012 in FIG. 1. In addition, the circuit board 102 in FIG. 1 is omitted in the control button 10A. Moreover, in the touch panel 20A, the touch-sensing element 201A include a plurality of signal electrodes S5 and a plurality of ground electrodes GND. The plurality of signal electrodes S5 and the plurality of ground electrodes GND are alternately arranged along a circumferential direction of the insulating main body 100.

When the insulating main body 100 is rotated, the conductive pad 1013 is rotated to the above of one of the electrodes S5 and the ground electrode GND adjacent to the one of the electrodes S5, so as to cause the one of the electrodes S5 to generate capacitance change with respect to the ground. According to the location of the electrode S5 that generates capacitance change with respect to the ground, the location of the conductive pad 1013 and the absolute angle can be determined, so as to achieve the function of controlling parameter(s), such as temperature, humidity, wind speed, volume of sound, etc.

When the insulating main body 100 is rotated, in order that the conductive pad 1013 is able to cover one of the signal electrodes S5 and the ground electrode GND corresponding to the one of the signal electrodes S5, the area of the conductive pad 1013 is 1.5 to 2 times the area of each of the signal electrodes S5, and the area of the conductive pad 1013 is 1.5 to 2 times the area of each of the ground electrodes GND. In the embodiment, the area of the electrode S5 is equal to the area of the ground electrode GND.

The number and the shape of each electrode in the touch-sensing element 201, and the relative arranging relationship of these elements (such as the electrodes, the conductive wires W, and the pads P) in the touch-sensing element 201 may be adjusted according to requirement and are not limited by FIG. 6. For example, the number of the electrodes S5 and the number of the ground electrodes GND may be increased to improve precision of the rotation control.

It should be noted here, electrode design of the touch-sensing element 201A is not limited to self-capacitive sensing design. In one embodiment, the touch-sensing element 201A may include a plurality of driving electrodes, a plurality of sensing electrodes and a plurality of ground electrodes, so as to realize touch detection through mutual capacitance sensing method. Under this structure, the plurality of driving electrodes, the plurality of sensing electrodes and the plurality of ground electrodes are alternately arranged along the circumferential direction of the insulating main body. Additionally, when the insulating main body is rotated, in order that the conductive pad is able to cover one of the driving electrodes and the sensing electrode and the ground electrode corresponding to the one of the signal electrodes, the area of the conductive pad is 2.5 to 3 times the area of each of the driving electrodes, the area of the conductive pad is 2.5 to 3 times the area of each of the sensing electrodes, and the area of the conductive pad is 2.5 to 3 times the area of each of the ground electrodes.

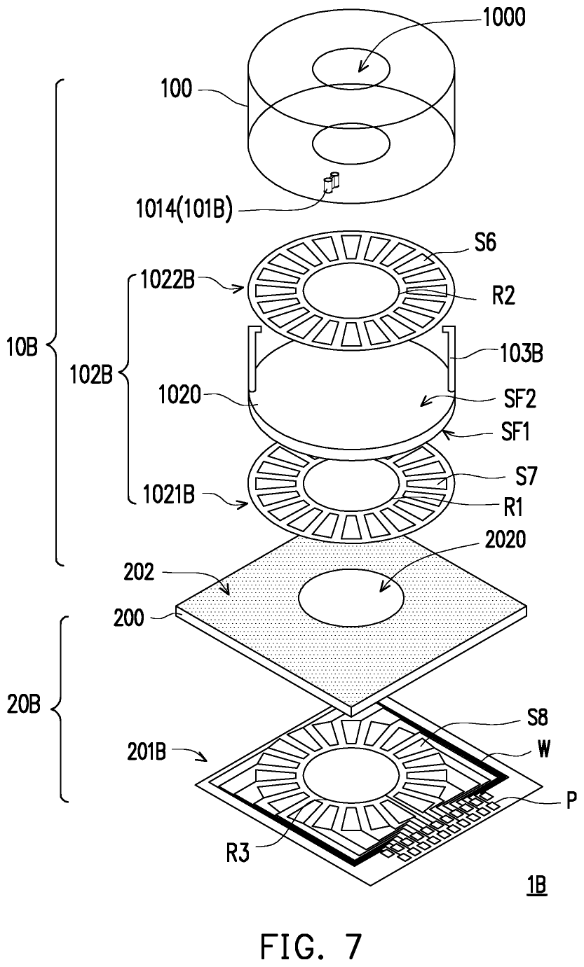

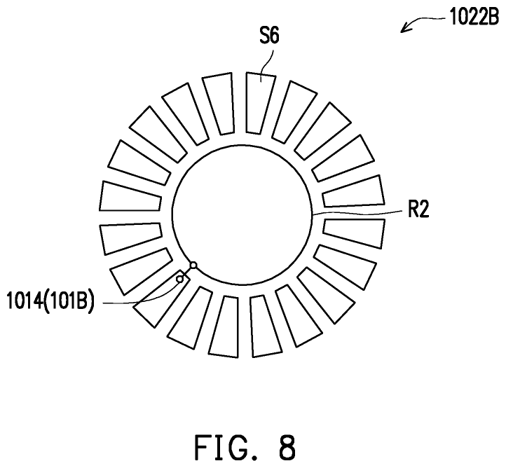

FIG. 7 is an exploded view of a touch apparatus 1B according to the third embodiment of the disclosure. FIG. 8 is a front view showing the relative relationship in operation between a second circuit layer 1022B and a conductive member 101B in FIG. 7. Referring to FIG. 7 and FIG. 8, the main differences between the touch apparatus 1B and the touch apparatus 1 in FIG. 1 are described as follows. In the touch apparatus 1B, the conductive member 101B of the control button 10B only includes one elastic piece 1014. In addition, the second circuit layer 1022B includes a plurality of second electrodes S6. The plurality of second electrodes S6 of the second circuit layer 1022B are overlapped with and electrically connected to the plurality of first electrodes S7 of the first circuit layer 1021B, respectively. To be more specific, in FIG. 1, the second circuit layer 1022 adopts a different circuit design than the first circuit layer 1021. In FIG. 7, the second circuit layer 1022B adopts a circuit design similar to or the same as the circuit design of the first circuit layer 1021B. The same circuit design indicates that the plurality of second electrodes S6 of the second circuit layer 1022B and the plurality of first electrodes S7 of the first circuit layer 1021B have the same pattern, size, and relative arranging location of the elements. The similar circuit design indicates that the plurality of second electrodes S6 of the second circuit layer 1022B and the plurality of first electrodes S7 of the first circuit layer 1021B have the same relative arranging location of the elements, but may not have the same pattern and size. For example, the pattern of the second electrode S6 may be a fan shape, and the pattern of the first electrode S7 may be a rectangular shape. Alternatively, the size of the second electrode S6 may be greater or smaller than the size of the first electrode S7.

Moreover, the touch-sensing element 201B includes a plurality of electrodes S8, and the plurality of electrodes S8 of the touch-sensing element 201B and the plurality of second electrodes S6 of the second circuit layer 1022B may have the same or similar pattern, size, and relative arranging location of the elements.

In the embodiment, the first circuit layer 1021B further includes a first ground ring R1. The second circuit layer 1022B further includes a second ground ring R2. The touch-sensing element 201B further includes a third ground ring R3. The first ground ring R1 and the second ground ring R2 are electrically connected to each other. In addition, the first ground ring R1, the second ground ring R2, and the third ground ring R3 are overlapped with each other. To be more specific, the first ground ring R1 is located between the plurality of first electrodes S7 and is surrounded by the plurality of first electrodes S7, for example. The second ground ring R2 is located between the plurality of second electrodes S6 and is surrounded by the plurality of second electrodes S6, for example. The third ground ring R3 is located between the plurality of electrodes S8 and is surrounded by the plurality of electrodes S8, for example. However, the shape and the number of the ground rings and the relative arranging relationship between the ground rings and the electrodes may be adjusted according to requirement and is not limited by FIG. 7.

When the insulating main body 100 is rotated, the elastic piece 1014 is in contact with one of the plurality of second electrodes S6 of the second circuit layer 1022B and the second ground ring R2 (as shown in FIG. 8), so as to cause the corresponding electrode S8 in the touch-sensing element 201B to generate capacitance change with respect to the ground. According to the location of the electrode S8 that generates capacitance change with respect to the ground, the absolute rotating angle can be determined, so as to achieve accurate control of the parameter(s), such as temperature, humidity, wind speed, volume of sound, etc.

In the embodiment, the control button 10B further includes a plurality of position restricted parts 103B. The plurality of position restricted parts 103B are fixed on the second surface SF2 and disposed along the periphery of the insulating main body 100, so as to limit the location of the insulating main body 100 and to prevent the insulating main body 100 from moving in the horizontal direction.

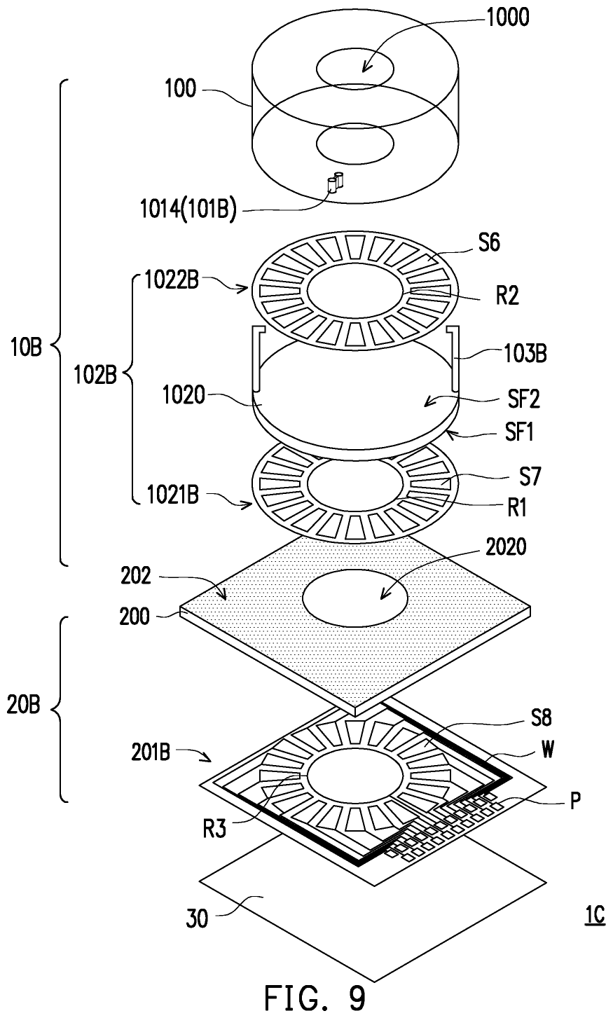

FIG. 9 is an exploded view of a touch apparatus 1C according to the fourth embodiment of the disclosure. Referring to FIG. 9, the main differences between the touch apparatus 1C and the touch apparatus 1B in FIG. 7 are described as follows. The touch apparatus 1C further includes a display device 30, wherein the touch-sensing element 201B is located between the cover plate 200 and the display device 30. The display device 30 is configured to display information and may adopt any known display device, such as liquid crystal display device, organic light emitting display device, and micro light emitting diode display device, etc., but the disclosure is not limited thereto. In any of the foregoing embodiments, the display device 30 may be integrated in each of the touch apparatuses according to requirement.

In summary, according to embodiments of the touch apparatus of the disclosure, the main body of the control button is made of insulating material. Since the insulating material is not easy to conduct heat, the temperature of the control button is not easily affected by ambient temperature. In addition, the user can operate the control button while wearing the glove. In one embodiment, the rotating angle of the control button can be determined by disposition of the circuit board and the corresponding circuit/electrode design, so as to achieve the function of accurate control of parameter(s), such as temperature, humidity, wind speed, volume of sound, etc. In another embodiment, the rotating angle of the control button can be determined by designing the areas of the conductive pad of the conductive member and the electrode of the touch-sensing element, so as to achieve the function of accurate control of parameter(s), such as temperature, humidity, wind speed, volume of sound, etc., and can omit the circuit board.

Although the disclosure has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A touch apparatus, comprising:
a control button comprising an insulating main body and a conductive member disposed on the insulating main body; and
a touch panel disposed on a side of the control button, and the touch panel comprising:
a cover plate, wherein the conductive member is located between the insulating main body and the cover plate; and
a touch-sensing element, wherein the cover plate is located between the conductive member and the touch-sensing element, the touch-sensing element is electrically insulated from the conductive member, the touch-sensing element comprises a plurality of electrodes disposed corresponding to the control button, the conductive member moves along with movement of the insulating main body, and the movement of the conductive member causes a capacitance change of at least one of the plurality of electrodes.

2. The touch apparatus as recited in claim 1, wherein the conductive member comprises at least one elastic piece, and the control button further comprises:
a circuit board located between the conductive member and the touch panel, and the circuit board comprising:
a circuit substrate having a first surface and a second surface, and the second surface being located between the conductive member and the first surface;
a first circuit layer disposed on the first surface, wherein the first circuit layer comprises a plurality of first electrodes, and the plurality of first electrodes respectively overlap the plurality of electrodes of the touch-sensing element; and
a second circuit layer disposed on the second surface and electrically connected to the first circuit layer, wherein the movement of the insulating main body causes the conductive member to be in contact with the second circuit layer.

3. The touch apparatus as recited in claim 2, wherein the circuit board does not move along with the movement of the insulating main body.

4. The touch apparatus as recited in claim 2, wherein the at least one elastic piece comprises a first elastic piece and a plurality of second elastic pieces, and the first elastic piece is shorter than each of the second elastic pieces,
the second circuit layer comprises a first conductive wire, a second conductive wire, a third conductive wire, a first ground wire and a second ground wire, the first conductive wire, the first ground wire, the second conductive wire, the second ground wire and the third conductive wire are sequentially arranged in a concentric manner from inside to outside or from outside to inside, the first conductive wire, the second conductive wire, the third conductive wire and the first ground wire are continuous conductive wires, the second ground wire is constituted by a plurality of conducting portions, and the plurality of conducting portions are separated from each other, wherein
when the insulating main body is pressed, the first elastic piece is in contact with the first conductive wire and the first ground wire, and when the insulating main body is rotated, the plurality of second elastic pieces are respectively in contact with the second conductive wire and the third conductive wire, and the plurality of second elastic pieces are intermittently in contact with the plurality of conducting portions.

5. The touch apparatus as recited in claim 2, wherein the second circuit layer comprises a plurality of second electrodes, and the plurality of second electrodes of the second circuit layer are overlapped with and electrically connected to the plurality of first electrodes of the first circuit layer, respectively,
the first circuit layer further comprises a first ground ring, the second circuit layer further comprises a second ground ring, the touch-sensing element further comprises a third ground ring, the first ground ring and the second ground ring are electrically connected to each other, and the first ground ring, the second ground ring, and the third ground ring are overlapped with each other, wherein
when the insulating main body is rotated, the at least one elastic piece is in contact with one of the plurality of second electrodes of the second circuit layer and the second ground ring.

6. The touch apparatus as recited in claim 2, wherein the control button further comprises:
a plurality of position restricted parts fixed on the second surface and disposed along a periphery of the insulating main body.

7. The touch apparatus as recited in claim 1, wherein the conductive member comprises a conductive pad, the plurality of electrodes of the touch-sensing element comprise a plurality of signal electrodes and a plurality of ground electrodes, the plurality of signal electrodes and the plurality of ground electrodes are alternately arranged along a circumferential direction of the insulating main body, an area of the conductive pad is 1.5 to 2 times an area of each of the plurality of signal electrodes, and the area of the conductive pad is 1.5 to 2 times an area of each of the plurality of ground electrodes.

8. The touch apparatus as recited in claim 1, wherein the conductive member comprises a conductive pad, the plurality of electrodes of the touch-sensing element comprise a plurality of driving electrodes, a plurality of sensing electrodes and a plurality of ground electrodes, the plurality of driving electrodes, the plurality of sensing electrodes and the plurality of ground electrodes are alternately arranged along a circumferential direction of the insulating main body, an area of the conductive pad is 2.5 to 3 times an area of each of the plurality of driving electrodes, the area of the conductive pad is 2.5 to 3 times an area of each of the plurality of sensing electrodes, and the area of the conductive pad is 2.5 to 3 times an area of each of the plurality of ground electrodes.

9. The touch apparatus as recited in claim 1, wherein the insulating main body has a center opening, and the center opening exposes at least one of the plurality of electrodes of the touch-sensing element.

10. The touch apparatus as recited in claim 1, further comprising:
a display device, wherein the touch-sensing element is located between the cover plate and the display device.
